(19) United States
(12) Patent Application Publication
(10) Pub. No.: US 2025/0343303 A1
(43) Pub. Date: Nov. 6, 2025

(54) Magnesium Air Battery and Manufacturing Method of It

(71) Applicant: Nippon Telegraph and Telephone Corporation, Tokyo (JP)

(72) Inventors: Hiroaki Taguchi, Musashino-shi, Tokyo (JP); Takeshi Komatsu, Musashino-shi, Tokyo (JP); Masaya Nohara, Musashino-shi, Tokyo (JP); Sho Okubo, Musashino-shi, Tokyo (JP); Shuhei Sakamoto, Musashino-shi, Tokyo (JP)

(21) Appl. No.: 18/870,068

(22) PCT Filed: May 31, 2022
(86) PCT No.: PCT/JP2022/022126

§ 371 Date: Nov. 27, 2024

(51) Int. Cl. H01M 12/06; H01M 4/38; H01M 4/88; H01M 4/96; H01M 50/103; H01M 50/51

(52) U.S. Cl. CPC H01M 12/065; H01M 4/381; H01M 4/8882; H01M 4/96; H01M 50/103; H01M 50/51; H01M 2300/0002; H01M 2300/0085

(57) ABSTRACT

A magnesium-air battery includes a positive electrode composed of an air electrode, a negative electrode made of magnesium or a magnesium alloy containing magnesium and any one or more of the group consisting of iron, calcium, and aluminum, and an electrolyte which is disposed between the positive electrode and the negative electrode and is composed of a salt.

### TECHNICAL FIELD

The present invention relates to a magnesium-air battery and a method for manufacturing the same.

### BACKGROUND ART

Conventionally, alkaline batteries and manganese batteries have been widely used as disposable primary batteries. In addition, in recent years, with the development of the Internet of Things (IoT), the development of deployed sensors existing in any place in nature such as in the soil or in forests has also progressed, and not only conventional mobile devices but also small and high-performance lithium ion batteries corresponding to various applications such as for these sensors have become widespread.

However, conventional disposable batteries are often composed of resources such as lithium, nickel, manganese, and cobalt, and have a problem of resource depletion. In addition, since a strong alkali or a harmful organic electrolytic solution such as a sodium hydroxide aqueous solution is used as the electrolytic solution, there is a problem of soil contamination in a final disposal site. Furthermore, depending on the environment in which the disposable battery is used, for example, when the disposable battery is used as a drive source of a sensor embedded in soil, there is a problem that the surrounding environment may be adversely affected.

Systematized legislation is being developed in consideration of these environmental influences.

There are laws for the management of chemical substances for which there is concern regarding their influence on human health via the environment and the environment. The purpose of the chemical substances management laws is to, while considering the trend in international cooperation on the management of chemical substances related to environmental conservation and based on scientific knowledge regarding chemical substances and the situation related to the manufacture, use, and other handling, and with the understanding of business operators and public, promote voluntary improvement in the management of chemical substances by business operators and prevent problems in environmental conservation by taking measures related to understanding of the amounts and the like of specific chemical substances released into the environment and measures related to the provision of information related to the properties and handling of specific chemical substances by business operators.

As the chemical substances management laws, the Chemical Substance Examination and Regulation Law, the Pollutant Release and Transfer Register (PRTR) Law, the Pesticide Control Law, the Air Pollution Control Law, the Water Pollution Control Law, the Soil Contamination Countermeasures Law, the Waste Disposal and Public Cleansing Law, the Poisonous and Deleterious Substances Control Law, the Ozone Layer Protection Law, and the Fluorocarbons Recovery and Destruction Law may be designated.

There are concerns regarding environmental problems caused by batteries containing substances designated in these laws and regulations being discarded or forgotten about without being recycled or the like.

In addition, as an example, in terms of classification according to the above-described Chemical Substance Examination and Regulation Law, there are substances with high risks such as long-term toxicity and persistence, Class 1 and 2 specified chemicals, monitoring chemicals, and priority assessment chemicals, while there are also general chemical substances, which are general chemicals whose risk is of less concern. General chemical substances existing in the market should not be designated as chemical substances that for which there is concern regarding environmental problems in these laws and regulations (Non Patent Literature 1 and Non Patent Literature 2).

Zinc is used as a constituent element contained in a magnesium alloy of a negative electrode of a commercially available magnesium-air battery or as a negative electrode material of a commercially available dry battery. However, the influence of zinc, for example, in the form of water-soluble compounds of zinc, is designated in the list of Class 1 designated chemical substances in the Pollutant Release and Transfer Register Law (Non Patent Literature 3 and Non Patent Literature 4). It is described that metal zinc, zinc oxide, and the like dissolve in acidic and basic aqueous solutions.

In order to solve the above environmental problems, an air

battery is one of batteries that are being researched and developed as next-generation batteries. In an air battery, oxygen in air used as a positive electrode active material is supplied from the outside of the battery, and thus the inside of the battery cell can be filled with a metal negative electrode. A metal such as magnesium, aluminum, or zinc can be used for the negative electrode. When a material rich in resources is used, a battery having low cost and low environmental impact can be formed. In particular, zinc-air batteries using zinc for a negative electrode have been commercialized as a drive source for hearing aids and the like, and magnesium-air batteries using magnesium for a negative electrode have been researched and developed as primary batteries having a low environmental impact (Non Patent Literature 5 and Non Patent Literature 6).

### CITATION LIST

### Non Patent Literature

Non Patent Literature 1: Ministry of Economy, Trade and Industry, Chemical Management Division, “Kagaku busshitsu kanri seisaku no genjo to kadai (in Japanese) (Current status and challenges of chemical substance management policy)” (P4), [online], October 2012, [retrieved on May 20, 2022], Internet <URL: https://www.nite.go.jp/data/000010340.pdf>

Non Patent Literature 2: “Kagaku busshitsu kanren hoki (in Japanese) (Chemical substance related laws and regulations)” (P4), [online], [retrieved on May 20, 2022], Internet <URL: https://www.env.go.jp/chemi/communication/taiwa/text/2_2008.pdf>

Non Patent Literature 3: “Kagaku busshitsu haishutsu haaku kanri sokushin ho dai isshu shitei kagaku busshitsu list (in Japanese) (Pollutant Release and Transfer Register Law: List of Class 1 designated chemical substances)”, [online], [retrieved on May 20, 2022], Internet <URL: https://www.meti.go.jp/policy/chemical_management/law/prtr/pdf/sind ail. pdf>

Non Patent Literature 4: “Kagaku busshitsu haishutsu haaku kanri sokushin ho aen no suiyosei kagobutsu (in Japanese) (Pollutant Release and Transfer Register Law: Water-soluble Compounds of Zinc)”, [online], [retrieved on May 20, 2022], Internet <URL: https://www.nite.go.jp/chem/chrip/chrip_search/dt/pdf/CI_02_001/ris k/pdf_gaiyou/001gaiyou. pdf>

Non Patent Literature 5: Yejian Xue et al., “Template-directed fabrication of porous gas diffusion layer for magnesium air batteries”, Journal of Power Sources 297 (2015) 202e207

Non Patent Literature 6: Naiguang Wang et al., “Discharge behaviour of Mg—Al—Pb and Mg—Al—Pb—In alloys as anodes for Mg-air battery”, Electrochimica Acta 149 (2014) 193-205

### SUMMARY OF INVENTION

### Technical Problem

However, in the air electrode disclosed in Non Patent Literature 5, a fluororesin is used as a binder. This fluorine is designated as a hazardous substance as fluorine and fluorine compounds under the Soil Contamination Countermeasures Law or the Water Pollution Control Law. In addition, in Non Patent Literature 6, metals containing lead and indium are used for the negative electrode, and there is concern regarding the influence of the material composition on the natural environment, such as soil contamination. Note that chlorine contained in sodium chloride, which is easily and widely used as an electrolyte, can cause corrosion in the furnace and become a component of toxic substances such as dioxins when mixed into general waste incineration facilities.

Thus, there is a need for batteries that do not pollute waste treatment facilities made of only materials having a low environmental impact and the natural environment, without using regulated substances for which there is concern regarding their influence on human health via the environment and the environment as stipulated by laws and regulations.

The present invention has been made in view of the above circumstances, and an object of the present invention is to provide a battery made of a material having a low environmental impact.

### Solution to Problem

According to one aspect of the present invention, there is provided a magnesium-air battery including: a positive electrode composed of an air electrode; a negative electrode made of magnesium or a magnesium alloy containing magnesium and any one or more of the group consisting of iron, calcium, and aluminum; and an electrolyte which is disposed between the positive electrode and the negative electrode and is composed of a salt.

According to one aspect of the present invention, there is provided a method for manufacturing a magnesium-air battery, the method including: a step of obtaining a positive electrode composed of an air electrode; a step of obtaining a negative electrode made of magnesium or a magnesium alloy containing magnesium and any one or more of the group consisting of iron, calcium, and aluminum; and a step of disposing an electrolyte composed of a salt between the positive electrode and the negative electrode, in which the air electrode is composed of a co-continuous body having a three-dimensional network structure formed of a plurality of nanostructures integrated by non-covalent bonds, and the step of obtaining the positive electrode includes: a freezing step of freezing a sol or gel in which the nanostructures are dispersed to obtain a frozen material; and a drying step of drying the frozen material in a vacuum to obtain the co-continuous body.

According to one aspect of the present invention, there is provided a method for manufacturing a magnesium-air battery, the method including: a step of obtaining a positive electrode composed of an air electrode; a step of obtaining a negative electrode made of magnesium or a magnesium alloy containing magnesium and any one or more of the group consisting of iron, calcium, and aluminum; and a step of disposing an electrolyte composed of a salt between the positive electrode and the negative electrode, in which the air electrode is composed of a co-continuous body having a three-dimensional network structure formed of a plurality of nanostructures integrated by non-covalent bonds, and the step of obtaining the positive electrode includes: a production step of causing bacteria to produce a gel in which nanofibers of any of iron oxide, manganese oxide, silicon, and cellulose are dispersed; and a carbonization step of heating and carbonizing the gel in an inert gas atmosphere to obtain the co-continuous body.

### Advantageous Effects of Invention

According to the present invention, it is possible to provide a battery made of a material having a low environmental impact.

### BRIEF DESCRIPTION OF DRAWINGS

FIG. 1 is a view schematically illustrating a magnesium-air battery according to an embodiment of the present invention.

FIG. 2 is a view schematically illustrating an appearance of a magnesium-air battery according to a first example.

FIG. 3 is a view schematically illustrating a cross section of the magnesium-air battery according to the first example.

FIG. 4 is a diagram for describing a battery voltage and a discharge capacity at the time of discharge in the magnesium-air battery according to the first example.

FIG. 5 is a view schematically illustrating an appearance of a magnesium-air battery according to a second example.

FIG. 6 is a view schematically illustrating a cross section of the magnesium-air battery according to the second example.

FIG. 7 is a diagram for describing a battery voltage and a discharge capacity at the time of discharge in the magnesium-air battery according to the second example.

### DESCRIPTION OF EMBODIMENTS

An embodiment of the present invention will be described below with reference to the drawings. In the drawings, the same portions are denoted by the same reference signs, and the description thereof will be omitted.

### (Magnesium-Air Battery)

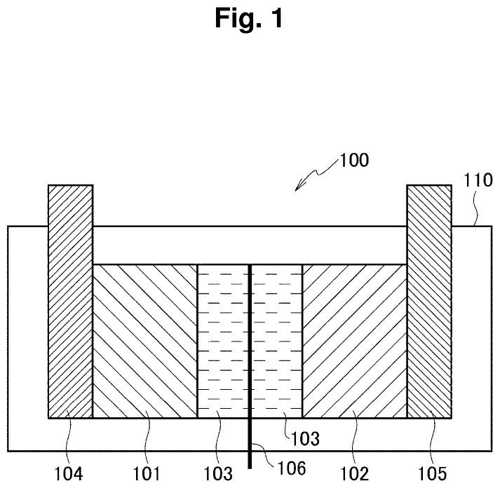

A magnesium-air battery 100 according to an embodiment of the present invention will be described with reference to FIG. 1. The magnesium-air battery 100 according to the embodiment of the present invention includes a positive electrode 101, a negative electrode 102, an electrolyte 103, a positive electrode current collector 104, a negative electrode current collector 105, a separator 106, and a housing 110.

The positive electrode 101 is composed of a gas diffusion type air electrode. The positive electrode 101 is composed of a co-continuous body having a three-dimensional network structure formed of a plurality of nanostructures integrated by non-covalent bonds. A binder, particularly a fluororesin as a binder, is not used for the air electrode.

The negative electrode 102 contains magnesium (Mg). The negative electrode 102 may be made of magnesium or a magnesium alloy containing magnesium and any one or more of the group consisting of iron (Fe), calcium (Ca), aluminum (Al), and the like. However, magnesium alloys containing a zinc component such as AZ31 are excluded.

The electrolyte 103 is disposed between the positive electrode 101 and the negative electrode 102 and is composed of a salt. The electrolyte 103 is an aqueous solution or gel containing magnesium acetate. The electrolyte 103 is preferably composed only of an aqueous solution or gel containing a salt such as magnesium acetate. Specifically, the electrolyte 103 may be composed of, for example, an aqueous solution of any salt of magnesium acetate, potassium chloride, and sodium chloride, or a mixture of these salts. Since the electrolyte 103 is composed of a salt, disposal is easy, there is no concern regarding the influence on the surrounding environment, and handling is easy. The electrolyte 103 may be either an electrolytic solution or a solid electrolyte. An electrolytic solution refers to a case where the electrolyte 103 is in a liquid form. Furthermore, a solid electrolyte refers to a case where the electrolyte 103 is in a gel form or a solid form. The solid electrolyte may contain agar, cellulose, water-absorbing polymer, etc. in order to have a water-retaining role. The electrolyte 103 may not be initially disposed in a state in which the magnesium-air battery 100 is not operated as a battery. The electrolyte 103 may be supplied from the outside through the separator 106, for example, when operating as a battery.

Known materials can be used for the positive electrode current collector 104. For the positive electrode current collector 104, for example, a carbon sheet, a carbon cloth, or an Fe or Al plate may be used.

Known materials can be used for the negative electrode current collector 105. In a case where metal is used for the negative electrode 102, the terminal may be directly taken out from the negative electrode 102 to the outside without using the negative electrode current collector 105.

The separator 106 is disposed between the positive electrode 101 and the negative electrode 102, and is provides insulation between the positive electrode 101 and the negative electrode 102. The separator 106 only needs to be an insulator having water absorbency. For the separator 106, for example, a coffee filter, a kitchen paper, or paper can be used. When a sheet of a material that is naturally decomposed while maintaining strength, such as a cellulose-based separator made of plant fibers, is used for the separator 106, the impact on the environment is low. The separator 106 may not be installed as long as insulation between the positive electrode and the negative electrode can be ensured.

The positive electrode 101 is in contact with the positive electrode current collector 104. When the positive electrode current collector 104 is exposed to the atmosphere, the positive electrode 101 is also exposed to the atmosphere. The positive electrode 101 is in contact with the electrolyte 103 on a surface other than the surface in contact with the positive electrode current collector 104.

The negative electrode 102 is in contact with the negative electrode current collector 105. The negative electrode 102 is in contact with the electrolyte 103 on a surface other than the surface in contact with the negative electrode current collector 105.

In the embodiment of the present invention, a case where the positive electrode current collector 104 and the negative electrode current collector 105 are provided will be described, but the present invention is not limited thereto. In a case where the strength of the positive electrode 101 and the negative electrode 102 is ensured at the time of connection with an external load, the positive electrode current collector 104 and the negative electrode current collector 105 can be omitted.

The housing 110 accommodates the positive electrode 101, the negative electrode 102, and the electrolyte 103. The electrolyte 103 may be accommodated inside the housing 110 when the magnesium-air battery 100 is in operation. The housing 110 has an air hole that exposes the positive electrode 101 (air electrode) to the atmosphere. The material and shape of the housing 110 are not particularly limited as long as it is a material that can maintain the battery cell inside and does not contain a regulated substance. However, a part of the positive electrode current collector 104 and a part of the negative electrode current collector 105 are exposed from the housing 110 for power supply.

For the housing 110, for example, a known laminate film type can be used. In a case where the housing 110 is made of a material that is naturally decomposed, the housing may be made of any material of a natural product type, a microbial type, and a chemical synthesis type, and can be made of, for example, polylactic acid, polycaprolactone, polyhydroxyalkanoate, polyglycolic acid, modified starch, or the like. In particular, a chemical synthesis type such as plant-derived polylactic acid is preferable. Further, the processing unit for the housing 110 can be formed using a 3D printer, cutting processing, and the like and the shape is not limited. In addition to a commercially available biodegradable plastic and its film, paper or an agar film on which a coating film of a resin such as polyethylene used for a milk pack or the like is formed can also be applied to the housing 110.

Here, the positive electrode 101 will be described in detail. For the positive electrode 101, a conductive material used for a positive electrode of a general well-known metal-air battery can be used. A representative example is a carbon material, but the material is not limited thereto. The positive electrode 101 can be produced by a known process such as molding carbon powder with a binder. In the primary battery, it is important to generate a large amount of reaction sites inside the positive electrode, and the positive electrode 101 desirably has a high specific surface area.

In the case of a general positive electrode that is produced by molding carbon powder with a binder and pelletizing the carbon powder, when the specific surface area is increased, the binding strength between the carbon particles becomes lower, and the structure deteriorates. Therefore, it becomes difficult to perform stable discharge, and the discharge capacity decreases.

Therefore, a co-continuous body having a three-dimensional network structure may be used as the positive electrode 101. By using a co-continuous body having a three-dimensional network structure for the positive electrode 101, it is not necessary to use a binder, and the discharge capacity can be increased.

A co-continuous body has, for example, a three-dimensional network structure in which a plurality of nanostructures are integrated by non-covalent bonds. The co-continuous body is a porous body and has an integral structure. The nanostructure is a nanosheet or a nanofiber. In a co-continuous body having a three-dimensional network structure in which a plurality of nanostructures are integrated by non-covalent bonds, a bonding portion between the nanostructures is deformable, and the co-continuous body has a stretchable structure.

Nanosheets are compounds that contain carbon or iron oxides and are mainly composed of carbon or iron oxide. The nanosheets are composed of at least one of carbon and iron oxide. It is important that the nanosheets have conductivity. A nanosheet is defined as a sheet-like substance having a thickness of 1 nm to 1 μm and a planar longitudinal and lateral length of 100 times or more the thickness. Examples of carbon nanosheets include graphene. Alternatively, the nanosheets may have a roll-like shape or a wave-like shape, or the nanosheets may be curved or bent, having any appropriate shape.

Nanofibers are compounds that contain carbon, iron oxides, or cellulose, and are mainly composed of carbon, iron oxide, or cellulose. The nanofibers are composed of at least one of carbon, iron oxide, and cellulose. It is important that the nanofibers also have conductivity. A nanofiber is defined as a fibrous substance having a diameter of 1 nm to 1 μm and a length of 100 times or more the diameter. Also, a nanofiber may have a hollow shape, a coil-like shape, or any other appropriate shape. Note that the cellulose to be used is carbonized to have conductivity, as will be described later.

### (Manufacturing Method)

Next, a method for manufacturing the magnesium-air battery 100 will be described. The manufacturing method includes a step of obtaining the positive electrode 101 composed of an air electrode, a step of obtaining the negative electrode 102 made of magnesium or a magnesium alloy containing magnesium and any one or more of the group consisting of iron, calcium, and aluminum, and a step of disposing the electrolyte 103 composed of a salt between the positive electrode 101 and the negative electrode 102. Here, the positive electrode 101 is composed of a co-continuous body having a three-dimensional network structure formed of a plurality of nanostructures integrated by non-covalent bonds.

The step of obtaining the positive electrode 101 includes a freezing step of freezing a sol or gel in which the nanostructures are dispersed to obtain a frozen material, and a drying step of drying the frozen material in a vacuum to obtain the co-continuous body. The positive electrode 101 is composed of the co-continuous body obtained in the drying step.

If the gel is a gel in which nanofibers made of any of iron oxide, manganese oxide, silicon, and cellulose are dispersed, predetermined bacteria may be caused to produce the gel. In this case, the step of obtaining the positive electrode 101 includes a production step of causing bacteria to produce a gel in which nanofibers of any of iron oxide, manganese oxide, silicon, and cellulose are dispersed, and a carbonization step of heating and carbonizing the gel in an inert gas atmosphere to obtain the co-continuous body. The positive electrode 101 is composed of the co-continuous body obtained in the carbonization step.

The co-continuous body constituting the positive electrode 101 preferably has an average pore size of 0.1 to 50 μm, and more preferably 0.1 to 2 μm, for example. Here, the average pore size is a value obtained by a mercury intrusion method. In this case, it is not necessary to use an additional material such as a binder as in the case of using carbon powder, which is advantageous in terms of cost and environmental aspects.

### (Electrochemical Reaction)

Here, an electrochemical reaction in the positive electrode 101 and the negative electrode 102 will be described by taking the case of a primary battery using magnesium metal for the negative electrode as an example. In a positive electrode reaction, the oxygen in the air and the electrolyte come into contact with each other on the surface of the positive electrode 101 having conductivity, so that a reaction expressed by “½O₂+H₂O+2e⁻→2OH . . . (1)” proceeds. On the other hand, in a negative electrode reaction, a reaction of “Mg→Mg²⁺+2e⁻. . . (2)” proceeds in the negative electrode 102 in contact with the electrolyte 103, and magnesium constituting the negative electrode 102 emits electrons and dissolves in the electrolyte as magnesium ion.

Through these reactions, discharge can be performed. The overall reaction becomes “Mg+½O₂+H₂O+2e⁻→Mg(OH)² . . . (3)”, and is a reaction in which magnesium hydroxide is produced (precipitated). The theoretical electromotive force is about 2.7 V. In this manner, in the primary battery, since the reaction represented by Formula (1) proceeds on the surface of the positive electrode 101, it is considered to be better to generate a large amount of reaction sites inside the positive electrode 101.

The magnesium-air battery 100 according to the embodiment of the present invention does not pollute a waste treatment facility made of a material having a low environmental impact and a natural environment. The magnesium-air battery 100 is made only of a material containing no regulated substance specified by various laws and regulations. For example, when the magnesium-air battery 100 is used in a disposable device such as a soil moisture sensor, the impact on the living environment and the natural environment is extremely low even when the magnesium-air battery is not collected or discarded as general waste.

### First Example

A first example according to the embodiment of the present invention will be described. A first example is an example in which a co-continuous body having a three-dimensional network structure formed of a plurality of nanosheets integrated by non-covalent bonds is used as an air electrode (positive electrode 101).

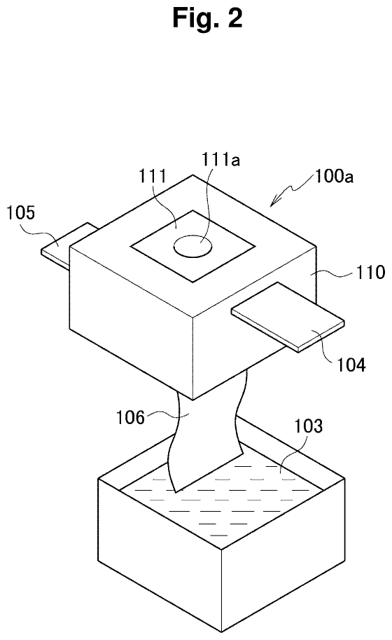

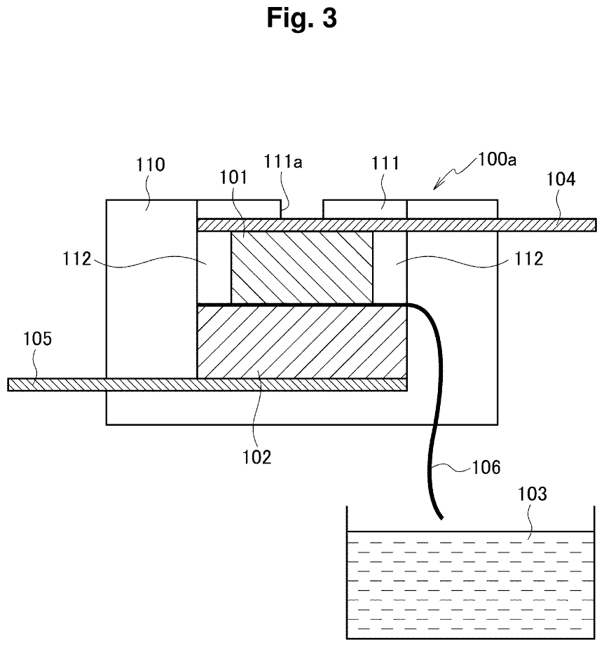

As illustrated in FIGS. 2 and 3, a magnesium-air battery 100a according to the first example includes a positive electrode 101, a negative electrode 102, an electrolyte 103, a positive electrode current collector 104, a negative electrode current collector 105, a separator 106, a housing 110, a housing lid 111, and a fixture 112.

An air electrode, which is the positive electrode 101, was synthesized as follows. In the following description, as a representative, a manufacturing method using graphene as a nanosheet will be shown, but by changing graphene to nanosheets made of another material, a co-continuous body having a three-dimensional network structure can be adjusted.

First, a method for producing the positive electrode 101 will be described. A commercially available carbon nanofiber sol [dispersion medium: water (H₂O), 0.4 weight %, manufactured by Sigma-Aldrich Co. LLC.] was placed in a test tube, and the test tube was immersed in liquid nitrogen for 30 minutes to completely freeze the carbon nanofiber sol. After completely freezing the carbon nanofiber sol, the frozen carbon nanofiber sol was taken out into an eggplant flask and dried in a vacuum of 10 Pa or less by a freeze dryer (manufactured by Tokyo Rikakikai Co., Ltd.) to obtain a stretchable co-continuous body having a three-dimensional network structure including carbon nanosheets.

The obtained co-continuous body was evaluated by performing X-ray diffraction (XRD) measurement, scanning electron microscope (SEM) observation, porosity measurement, a tensile test, and Brunauer Emmett Teller (BET) specific surface area measurement. The produced co-continuous body was confirmed to be carbon (C, PDF Card No. 01-075-0444) single phase by XRD measurement. Note that the PDF card No. is a card number of a powder diffraction file (PDF) which is a database collected by the International Centre for Diffraction Data (ICDD), and the same applies hereinafter. In addition, it was confirmed by SEM observation and a mercury intrusion method that the obtained co-continuous body was a co-continuous body in which nanosheets (graphene pieces) were continuously connected and which had an average pore size of 1 μm. In addition, the BET specific surface area of the co-continuous body was measured by a mercury intrusion method and found to be 510 m²/g. In addition, the porosity of the co-continuous body was measured by a mercury intrusion method and found to be 90% or more. Furthermore, from the results of the tensile test, it was confirmed that the obtained co-continuous body did not exceed the elastic region and restored to the shape before stress application even when 20% of strain was applied by tensile stress.

The co-continuous body was cut into a quadrangular shape having a side of 9 mm with a punching blade, a laser cutter, or the like to obtain a gas diffusion type air electrode (positive electrode 101).

For the positive electrode current collector 104, a PLA film of about 100 μm produced by dissolving and laminating a Poly-Lactic Acid (PLA) filament (manufactured by Raise 3D Inc.) by a Fused Filament Fabrication (FFF) method using a commercially available carbon paper (manufactured by Toray Industries, Inc.) and Raise 3D Pro2 (manufactured by Raise 3D Inc.) was integrated by compression molding under the conditions of 180° C. for 10 seconds at 5 kPa for use. The positive electrode current collector 104 was processed into a convex shape for connection with an external load. Specifically, a portion in contact with the positive electrode 101 was processed into a quadrangular shape having one side of 10 mm, and a portion connected to an external load was processed into a rectangular shape of 2 mm×10 mm.

The negative electrode 102 was obtained by cutting out a commercially available magnesium metal (thickness: 100 μm, manufactured by Fuji Light Metal Co., Ltd.) into a quadrangular shape having a side of 10 mm with a punching blade, a laser cutter, or the like.

For the negative electrode current collector 105, the same material as that of the negative electrode 102 processed into the same shape as that of the positive electrode current collector was used.

As the electrolyte 103, a solution obtained by dissolving magnesium acetate tetrahydrate (manufactured by Kanto Chemical Co., Inc.) in pure water at a concentration of 1 mol/L was used.

The separator 106 was a cellulose-based separator for batteries (manufactured by Nippon Kodoshi Corporation).

In order to accommodate each component, the housing 110 was formed to have an inner dimension of 10.1 mm square, an outer dimension of 20 mm, two gaps for positive and negative electrode current collectors for connection with an external load, and one gap for outputting a separator at the lower part. The housing 110 was produced by dissolving and laminating a PLA filament (manufactured by Raise 3D Technologies, Inc.) by a Fused Filament Fabrication (FFF) method using Raise 3D Pro2 (manufactured by Raise 3D Technologies, Inc.).

The housing lid 111 is a lid of the housing 110. The housing lid 111 fixes the positive electrode current collector 104 from above. The housing lid 111 has an air hole 111a for supplying atmosphere to the positive electrode current collector 104.

The fixture 112 is used for fixing the positive electrode 101. The fixture 112 has a quadrangular shape with an inner dimension of 9 mm and an outer dimension of 10 mm, and is formed to be capable of accommodating the positive electrode 101 therein.

Assembly of the magnesium-air battery 100a according to the first example will be described.

First, the negative electrode current collector 105, the negative electrode 102, and the separator 106 thereon are installed in the housing 110. A part of the negative electrode current collector 105 is exposed to the outside of the housing 110 from a gap for the negative electrode current collector of the housing 110, and a part of the separator 106 is exposed to the outside of the housing 110 from a gap for the separator provided below the housing 110. The fixture 112 for improving insulation and fixing the positive electrode is installed on the separator 106. The positive electrode 101 is stored inside the fixture 112, and the positive electrode current collector 104 is installed above it. At this time, a part of the positive electrode current collector 104 is exposed from the gap for the positive electrode current collector. The battery material was fixed with the housing lid 111 from the top, and the housing 110 and the housing lid 111 were fixed using heat generated by vibration of an ultrasonic cutter or the like. The electrolyte 103 was injected into the separator 106 exposed to the outside to produce the magnesium-air battery 100a.

The battery performance of the produced magnesium-air battery 100a was measured. First, a discharge test was performed. A discharge test of the air battery was performed using a commercially available charge and discharge measurement system (SD8 charge/discharge system manufactured by Hokuto Denko Corporation). In the discharge test, 0.5 mA/cm² was energized at a current density per effective area of the air electrode, and the measurement was performed in a thermostatic chamber at 25° C. (the atmosphere was under a normal living environment) until the battery voltage decreased from the open circuit voltage to 0 V. The discharge capacity was expressed as a value (mAh/g) per weight of the air electrode composed of the co-continuous body.

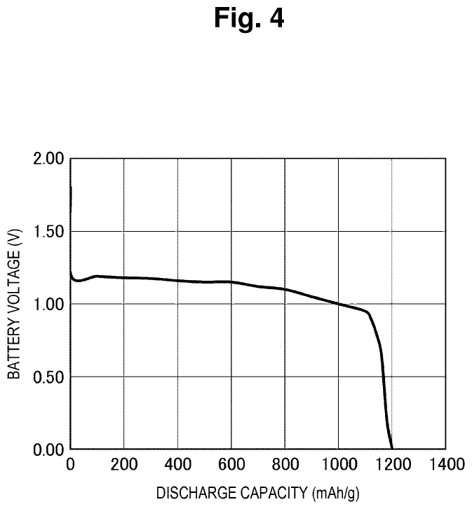

FIG. 4 shows an initial discharge curve in a case where the negative electrode is made of magnesium in the first example. As can be seen from FIG. 4, the average discharge voltage when the negative electrode 102 is made of magnesium and a co-continuous body is used for the air electrode is 1.15 V, and the discharge capacity is 1200 mAh/g. The average discharge voltage is a battery voltage at a discharge capacity of ½ of the discharge capacity of the battery. In the first example, the discharge capacity of the battery is 1200 mAh/g, and the discharge capacity in the experiment is 600 mAh/g.

### Second Example

A second example will be described. A magnesium-air battery 100b according to the second example is a multistage magnesium-air battery in which a plurality of battery cells including a positive electrode 101, a negative electrode 102, and an electrolyte 103 are connected in series. The magnesium-air battery 100b according to the second example is formed by connecting three battery cells in series.

The co-continuous body was cut into a quadrangular shape having a side of 9 mm with a punching blade, a laser cutter, or the like to obtain a gas diffusion type air electrode (positive electrode 101).

The positive electrode current collector 104 was processed into a convex shape for connection with an external load. Specifically, a portion in contact with the positive electrode 101 was processed into a quadrangular shape having one side of 10 mm, and a portion connected to an adjacent battery or an external load was processed into a rectangular shape of 2 mm×10 mm.

In order to be able to store three battery cells, the housing 110 was formed to have an inner dimension of 10.1 mm square (×3 cells), an outer dimension of 60 mm, two gaps for positive and negative electrode current collectors for connection with an external load and other cells, and one gap for outputting a separator at the lower part. The housing 110 was produced by dissolving and laminating a PLA filament (manufactured by Raise 3D Technologies, Inc.) by a Fused Filament Fabrication (FFF) method using Raise 3D Pro2 (manufactured by Raise 3D Technologies, Inc.).

The housing lid 111 is a lid of the housing 110. The housing lid 111 fixes the positive electrode current collector 104 from above. The housing lid 111 has an air hole 111a for supplying atmosphere to the positive electrode current collector 104.

The fixture 112 is used for fixing the positive electrode 101. The fixture 112 has a quadrangular shape with an inner dimension of 9 mm and an outer dimension of 10 mm, and is formed to be capable of accommodating the positive electrode 101 therein.

Assembly of the magnesium-air battery 100b according to the second example will be described.

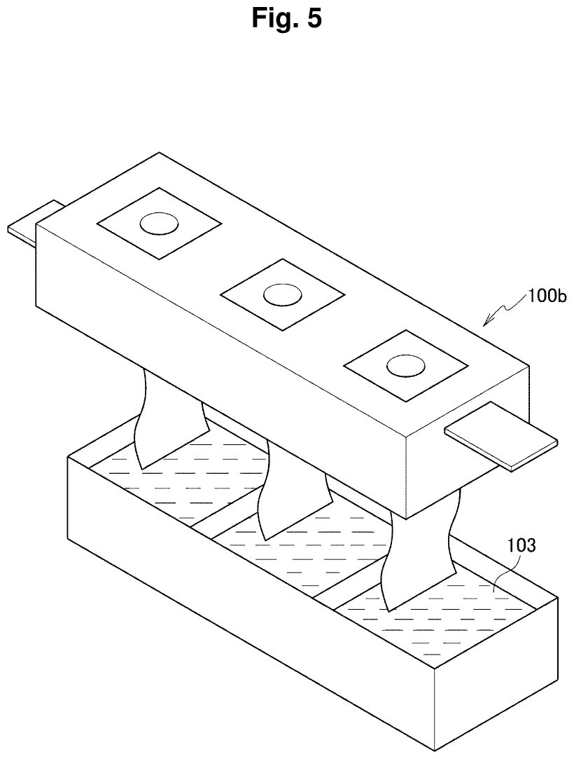

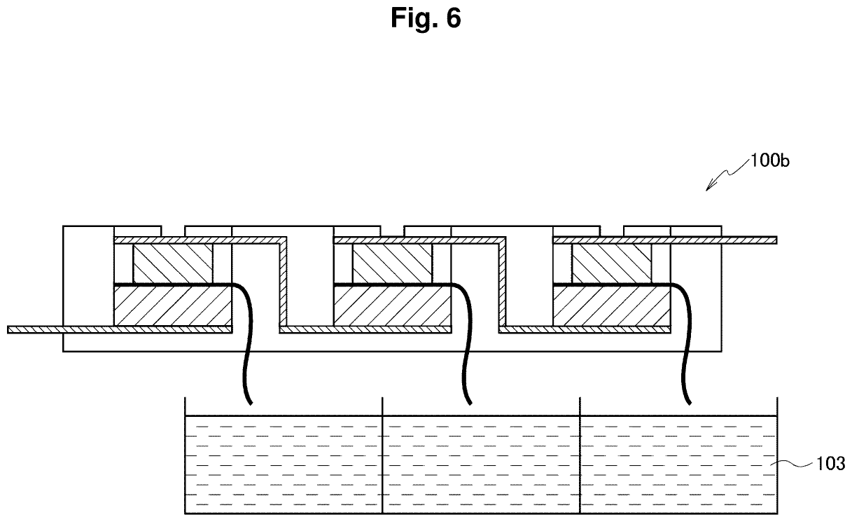

First, three sets each of the negative electrode current collector 105, the negative electrode 102, and the separator 106 thereon are installed in the housing 110. A part of the negative electrode current collector 105 at one end portion (the far side in FIG. 5 and the left side in FIG. 6) is exposed to the outside of the housing 110 from the gap for the negative electrode current collector of the housing 110. Parts of the three separators 106 are exposed to the outside of the housing 110 through a separator gap provided below the housing 110. Three fixtures 112 for improving insulation and fixing the positive electrode are installed on each of the three separators 106. Three positive electrodes 101 are stored inside each of the three fixtures 112, and three positive electrode current collectors 104 are installed above them. At this time, a part of the positive electrode current collector 104 at one end portion (the front side in FIG. 5 and the right side in FIG. 6) is exposed from the gap for the positive electrode current collector of the housing 110. At this time, the positive electrode current collector 104 of the battery cell accommodated in the housing 110 and the negative electrode current collector 105 of the adjacent battery cell are connected. The three battery cells in the housing 110 are connected in series. The battery material was fixed with three housing lids 111 from the top, and the housing 110 and the housing lid 111 were fixed using heat generated by vibration of an ultrasonic cutter or the like. The electrolyte 103 was injected into the separator 106 exposed to the outside to produce the magnesium-air battery 100a. Here, in order to avoid occurrence of a liquid junction, the electrolyte 103 is individually provided for each separator 106.

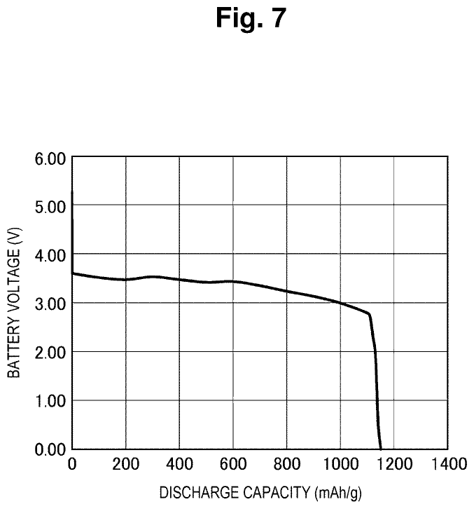

The battery performance of the produced magnesium-air battery 100b was measured. Discharge conditions were performed in the same manner as in the first example. As can be seen from FIG. 7, the average discharge voltage when the negative electrode 102 is made of magnesium and a co-continuous body is used for the air electrode is 3.39 V, and the discharge capacity is 1150 mAh/g. From this result, it was found that good results were obtained also in the magnesium-air battery 100b according to the second example.

According to the embodiment of the present invention, it is possible to provide the magnesium-air battery 100 that does not pollute waste treatment facilities made of only materials having a low environmental impact and the natural environment, without using regulated substances for which there is concern regarding their influence on human health via the environment and the environment. Such a magnesium-air battery 100 can be effectively used as various drive sources such as disposable batteries in daily environments and sensors used in soil.

Note that the present invention is not limited to the above embodiment, and various modifications can be made within the scope of the gist of the present invention.

### REFERENCE SIGNS LIST

100 Magnesium-air battery
101 Positive electrode
102 Negative electrode
103 Electrolyte
104 Positive electrode current collector
105 Negative electrode current collector
106 Separator
111 Housing lid
111a Air hole
112 Fixture

1. A magnesium-air battery comprising:
a positive electrode composed of an air electrode;
a negative electrode made of magnesium or a magnesium alloy containing magnesium and any one or more of the group consisting of iron, calcium, and aluminum; and
an electrolyte which is disposed between the positive electrode and the negative electrode and is composed of a salt.

2. The magnesium-air battery according to claim 1, wherein the air electrode is composed of a co-continuous body having a three-dimensional network structure formed of a plurality of nanostructures integrated by non-covalent bonds.

3. The magnesium-air battery according to claim 2, wherein the nanostructure of the air electrode
is a compound containing carbon or iron oxide, and is a nanosheet composed of at least one of carbon and iron oxide, or
is a compound containing carbon, iron oxide, or cellulose, and is a nanofiber composed of at least one of carbon, iron oxide, and cellulose.

4. The magnesium-air battery according to claim 1, wherein the electrolyte is an aqueous solution or gel containing magnesium acetate.

5. The magnesium-air battery according to claim 1, further comprising a housing that accommodates the positive electrode, the negative electrode, and the electrolyte,
wherein the housing has an air hole that exposes the air electrode to the atmosphere.

6. The magnesium-air battery according to claim 5, wherein battery cells including the positive electrode, the negative electrode, and the electrolyte are connected in series in the housing.

7. A method for manufacturing a magnesium-air battery, the method comprising:
a step of obtaining a positive electrode composed of an air electrode;
a step of obtaining a negative electrode made of magnesium or a magnesium alloy containing magnesium and any one or more of the group consisting of iron, calcium, and aluminum; and
a step of disposing an electrolyte composed of a salt between the positive electrode and the negative electrode, wherein
the air electrode is composed of a co-continuous body having a three-dimensional network structure formed of a plurality of nanostructures integrated by non-covalent bonds, and
the step of obtaining the positive electrode includes:
a freezing step of freezing a sol or gel in which the nanostructures are dispersed to obtain a frozen material; and
a drying step of drying the frozen material in a vacuum to obtain the co-continuous body.

8. A method for manufacturing a magnesium-air battery, the method comprising:
a step of obtaining a positive electrode composed of an air electrode;
a step of obtaining a negative electrode made of magnesium or a magnesium alloy containing magnesium and any one or more of the group consisting of iron, calcium, and aluminum; and
a step of disposing an electrolyte composed of a salt between the positive electrode and the negative electrode, wherein
the air electrode is composed of a co-continuous body having a three-dimensional network structure formed of a plurality of nanostructures integrated by non-covalent bonds, and
the step of obtaining the positive electrode includes:
a production step of causing bacteria to produce a gel in which nanofibers of any of iron oxide, manganese oxide, silicon, and cellulose are dispersed; and
a carbonization step of heating and carbonizing the gel in an inert gas atmosphere to obtain the co-continuous body.
